(19) United States
(12) Patent Application Publication
(10) Pub. No.: US 2017/0302965 A1
(43) Pub. Date: Oct. 19, 2017

(54) ADAPTIVE DIRECTIONAL LOOP FILTER

(71) Applicant: GOOGLE INC., Mountain View, CA (US)

(72) Inventors: Yaowu Xu, Saratoga, CA (US); Paul Wilkins, Cambridge (GB); James Bankoski, Los Gatos, CA (US)

(73) Assignee: GOOGLE INC., Mountain View, CA (US)

(21) Appl. No.: 15/130,022

(22) Filed: Apr. 15, 2016

(51) Int. Cl. H04N 19/82; H04N 19/117; H04N 19/176; H04N 19/86

(52) U.S. Cl. CPC H04N 19/82; H04N 19/86; H04N 19/117; H04N 19/176

(57) ABSTRACT

Adaptive directional loop filtering can reduce the number of blocking artifacts produced by coding a non-perpendicular picture edge in a frame of a video sequence. A directional filter is selected from a set of directional filters based on one of an orientation of the non-perpendicular picture edge or filter data included as part of an encoded video sequence in association with the frame. The selection can include selecting a directional filter based on a directional intra prediction mode used for encoding the block, a filter angle most closely matching an angle explicitly signaled as part of the video sequence, the incremental reduction of the number of blocking artifacts, a threshold value for blocking artifacts, or a frequency of filter use. Each directional filter of the set of directional filters can have a filter angle between 0 and 180 degrees, exclusive.

### BACKGROUND

Digital video streams typically represent video using a sequence of frames or still images. Each frame can include a number of blocks, which in turn may contain information describing the value of color, brightness or other attributes for pixels. The amount of data in a typical video stream is large, and transmission and storage of video can use significant computing or communications resources. Due to the large amount of data involved in video data, high performance compression and decompression is needed for transmission and storage.

### SUMMARY

Disclosed herein are aspects of systems, methods, and apparatuses for using adaptive directional loop filtering to reduce the number of blocking artifacts in a video stream. An apparatus according to one aspect of the disclosure comprises at least one processor configured to execute instructions stored in a non-transitory storage medium to identify, in a frame of an encoded video sequence, a current block comprising a picture edge that is non-perpendicular with respect to a boundary of the current block, select a directional filter from a set of directional filters based on filter signaling data included as part of the encoded video sequence in association with the frame, each directional filter having a filter angle, and apply the selected directional filter to the picture edge.

An apparatus according to another aspect of the disclosure comprises at least one processor configured to execute instructions stored in a non-transitory storage medium to identify, in a current block of a frame, a group of pixels defining a picture edge that is non-perpendicular with respect to a boundary of the current block, select a directional filter from a set of directional filters based on an orientation of the picture edge, each directional filter having a filter angle, and apply the selected directional filter to the picture edge during an encoding or decoding of the frame.

A method, according to another aspect of the disclosure, for encoding or decoding a video signal using a computing device, the video signal including frames defining a video sequence, each frame having blocks, and each block having pixels, comprises identifying, in a current block of a frame, a group of pixels defining a picture edge that is non-perpendicular with respect to a boundary of the current block, selecting a directional filter from a set of directional filters based on one of an orientation of the picture edge or filter signaling data included as part of an encoded video sequence in association with the frame, each directional filter having a filter angle, and applying the selected directional filter to the picture edge during an encoding or decoding of the frame.

These and other aspects of the present disclosure are disclosed in the following detailed description of the embodiments, the appended claims and the accompanying figures.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. Moreover, like numbers refer to like elements within the various figures.

FIG. 1 is a schematic of a video encoding and decoding system.

FIG. 2 is a block diagram of an example of a computing device that can implement a transmitting station or a receiving station.

FIG. 3 is a diagram of a typical video stream to be encoded and subsequently decoded.

FIG. 4 is a block diagram of a video compression system in according to an aspect of the teachings herein.

FIG. 5 is a block diagram of a video decompression system according to another aspect of the teachings herein.

FIG. 6 is a flowchart diagram of an example of a process for using adaptive directional loop filtering to reduce the number of blocking artifacts in a video stream.

FIG. 7 is a flowchart diagram of an example of a process for explicit signaling of a filter angle for adaptive directional loop filtering.

FIG. 8 is a flowchart diagram of an example of a process for using one or more filter angles for adaptive directional loop filtering.

### DETAILED DESCRIPTION

Many image and video coding techniques use block based prediction, transform, and quantization schemes. The use of block based prediction, transform, and quantization can give rise to discontinuities along block boundaries during encoding. These discontinuities, which are commonly referred to as blocking artifacts, can be visually distracting and reduce the quality of the decoded video and the effectiveness of the frame being used as a reference frame for subsequent frames. These discontinuities can be reduced by the application of an in-loop deblocking filter, or loop filter.

A loop filter is typically applied to a reconstructed frame or a portion of a reconstructed frame at the end of the decoding process and used to reduce blocking artifacts. Once a reconstructed frame is processed by the loop filter, it can be used as a reference frame for predicting subsequent frames in decoding a video sequence. Conventional loop filters use a technique for performing filtering operations perpendicular to block boundaries. For example, a vertical or horizontal boundary separating two adjacent blocks in a frame of a video sequence may be used by a conventional loop filter to reduce a number of blocking artifacts located within the adjacent blocks. While this technique can be effective for image textures containing picture edges that are perpendicular to block boundaries, it does not work well with image textures containing picture edges that are non-perpendicular to block boundaries.

Implementations of the present disclosure describe using adaptive directional loop filtering to reduce a number of blocking artifacts of a block within which a picture edge non-perpendicular with respect to a corresponding block boundary is at least partially located. A directional filter to be applied can be selected from a set of directional filters based, for example, on data explicitly signaled as part of the video sequence in association with a frame including the block, an orientation of the non-perpendicular picture edge, a threshold value with respect to a number of blocking artifacts of the block, a frequency of use, or other factors. Further details of adaptive directional loop filtering are described herein with initial reference to a system in which it can be implemented.

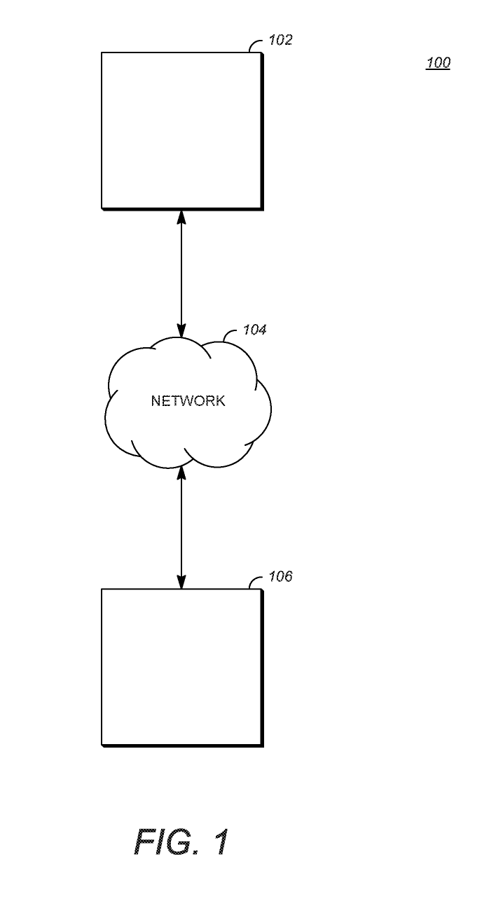

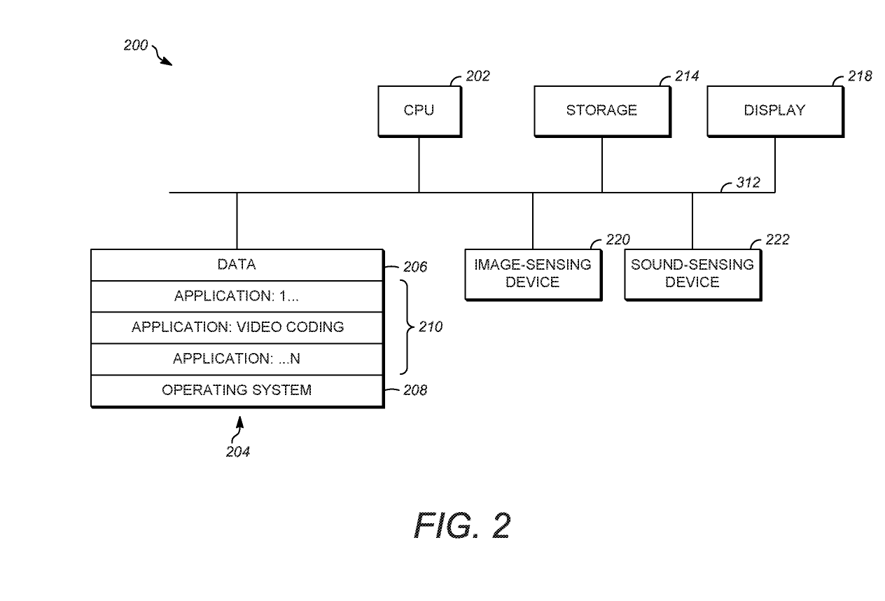

FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102 and the encoded video stream can be decoded in the receiving station 106. The network 104 can be, for example, the Internet. The network 104 can also be a local area network (LAN), wide area network (WAN), virtual private network (VPN), cellular telephone network or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., an HTTP-based video streaming protocol.

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits its own video bitstream to the video conference server for decoding and viewing by other participants.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of a single computing device, for example, a mobile phone, a tablet computer, a laptop computer, a notebook computer, a desktop computer, and the like.

A CPU 202 in the computing device 200 can be a conventional central processing unit. Alternatively, the CPU 202 can be any other type of device, or multiple devices, capable of manipulating or processing information now-existing or hereafter developed. Although the disclosed implementations can be practiced with a single processor as shown, e.g., the CPU 202, advantages in speed and efficiency can be achieved using more than one processor.

A memory 204 in computing device 200 can be a read only memory (ROM) device or a random access memory (RAM) device in an implementation. Any other suitable type of storage device can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described here. For example, the application programs 210 can include applications 1 through N, which further include a video coding application that performs the methods described here. Computing device 200 can also include a secondary storage 214, which can, for example, be a memory card used with a mobile computing device 200. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display or light emitting diode (LED) display, such as an OLED display.

The computing device 200 can also include or be in communication with an image-sensing device 220, for example a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into a single unit, other configurations can be utilized. The operations of the CPU 202 can be distributed across multiple machines (each machine having one or more of processors) that can be coupled directly or across a local area or other network. The memory 204 can be distributed across multiple machines such as a network-based memory or memory in multiple machines performing the operations of the computing device 200. Although depicted here as a single bus, the bus 212 of the computing device 200 can be composed of multiple buses. Further, the secondary storage 214 can be directly coupled to the other components of the computing device 200 or can be accessed via a network and can comprise a single integrated unit such as a memory card or multiple units such as multiple memory cards. The computing device 200 can thus be implemented in a wide variety of configurations.

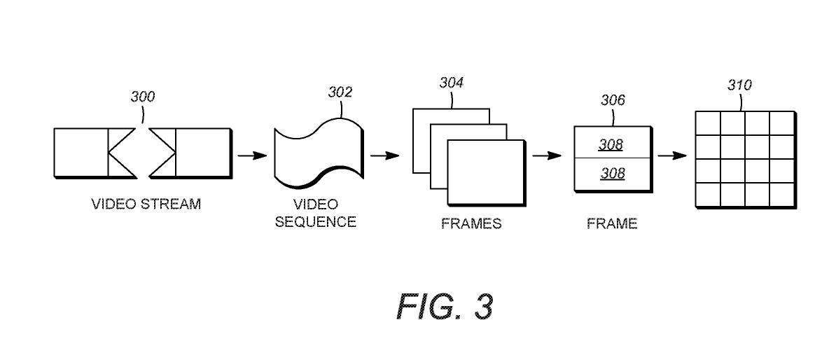

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, e.g., a single frame 306. At the next level, the single frame 306 can be divided into a series of segments or planes 308. The segments (or planes) 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more planes 308 of pixel data. The blocks 310 can also be of any other suitable size such as 4×4 pixels, 8×8 pixels, 16×8 pixels, 8×16 pixels, 16×16 pixels or larger. Unless otherwise noted, the terms block and macroblock are used interchangeably herein.

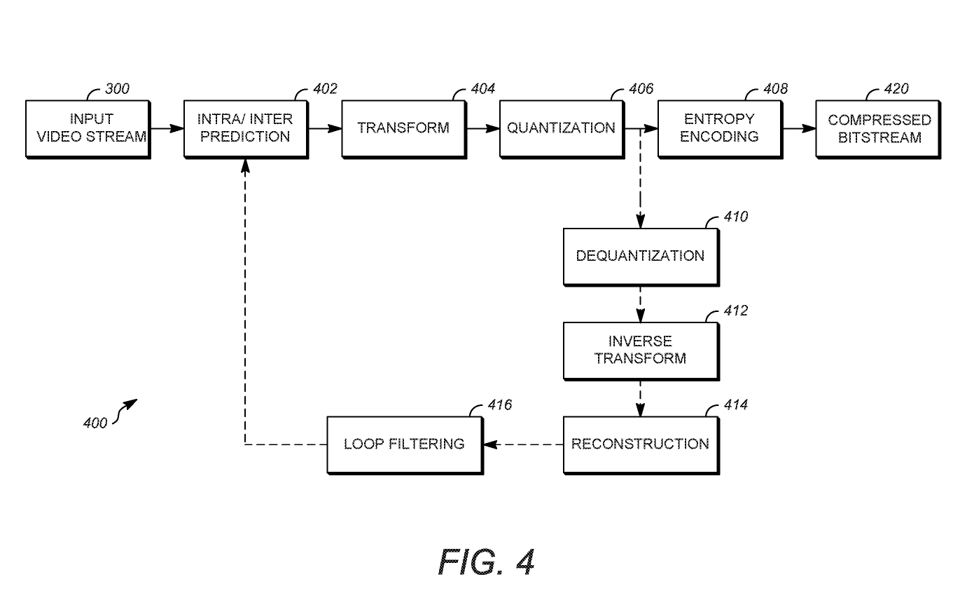

FIG. 4 is a block diagram of an encoder 400 in accordance with an implementation. The encoder 400 can be implemented, as described above, in the transmitting station 102 such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder. The encoder 400 has the following stages to perform the various functions in a forward path (shown by the solid connection lines) to produce an encoded or compressed bitstream 420 using the input video stream 300: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode video stream 300.

When the video stream 300 is presented for encoding, each frame 306 can be processed in units of blocks. At the intra/inter prediction stage 402, each block can be encoded using intra-frame prediction (also called intra prediction) or inter-frame prediction (also called inter prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block, which may include for example the type of prediction used, transform type, motion vectors and quantizer value, are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

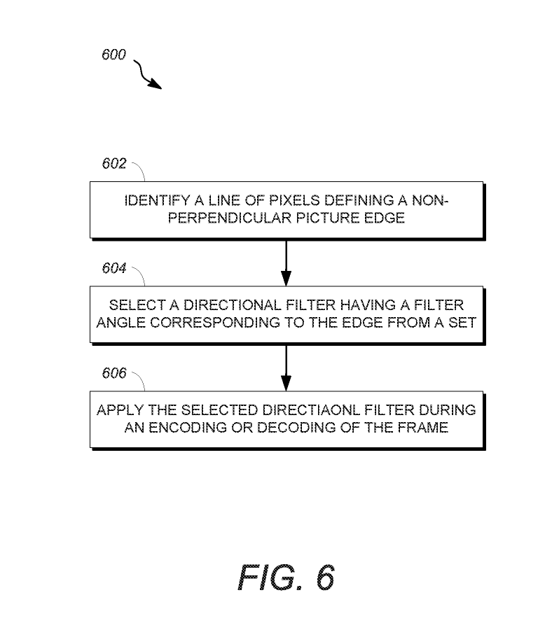

The reconstruction path in FIG. 4 (shown by the dotted connection lines) can be used to ensure that both the encoder 400 and a decoder 500 (described below) use the same reference frames to decode the compressed bitstream 420. The reconstruction path performs functions that are similar to functions that take place during the decoding process that are discussed in more detail below, including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts. Implementations for reducing blocking artifacts as part of a loop filtering stage 416 of a decoder 400 are discussed below with respect to FIGS. 6, 7, and 8, for example, by using adaptive directional loop filtering to reduce a number of blocking artifacts for a non-perpendicular picture edge.

Other variations of the encoder 400 can be used to encode the compressed bitstream 420. For example, a non-transform based encoder can quantize the residual signal directly without the transform stage 404 for certain blocks or frames. In another implementation, an encoder can have the quantization stage 406 and the dequantization stage 410 combined into a single stage.

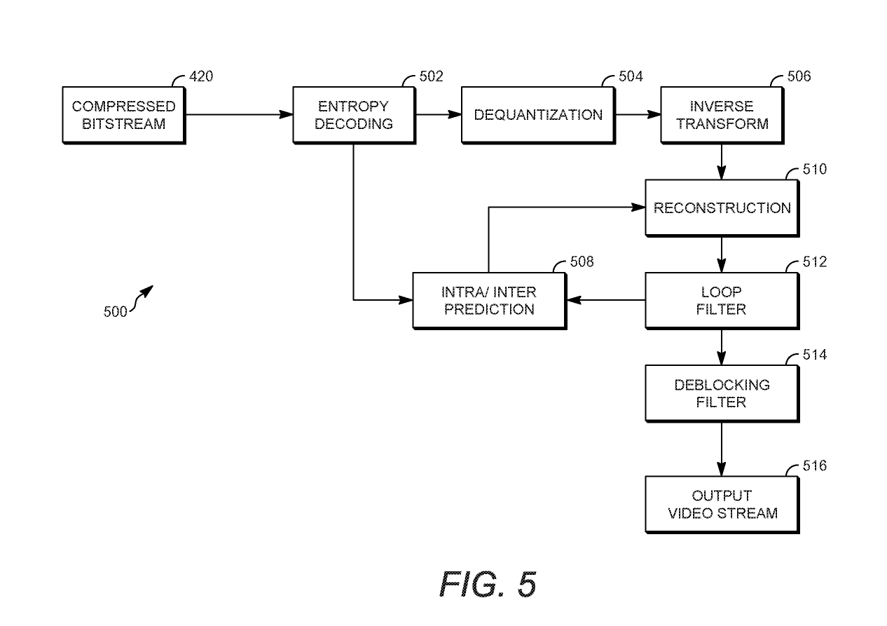

FIG. 5 is a block diagram of a decoder 500 in accordance with another implementation. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 408, a reconstruction stage 510, a loop filtering stage 512 and a deblocking filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts. Implementations for reducing blocking artifacts as part of a loop filtering stage 512 of a decoder 500 are discussed below with respect to FIGS. 6, 7, and 8, for example, by using adaptive directional loop filtering to reduce a number of blocking artifacts for a non-perpendicular picture edge.

Other filtering can be applied to the reconstructed block. In this example, the deblocking filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the deblocking filtering stage 514.

FIGS. 6, 7, and 8 are flowchart diagrams of processes 600, 700, and 800, respectively for using adaptive directional loop filtering to reduce the number of blocking artifacts in a video stream, explicit signaling of a filter angle for adaptive directional loop filtering, and using one or more filter angles for adaptive directional loop filtering. The processes 600, 700, and 800 can be implemented in a system such as the computing device 200 to aid in the encoding or decoding of a video stream. The processes 600, 700, and 800 can be implemented, for example, as a software program that is executed by a computing device such as the transmitting station 102 or the receiving station 106. The software program can include machine-readable instructions that are stored in a memory such as the memory 204 that, when executed by a processor such as the CPU 202, cause the computing device to perform one or more of the processes 600, 700, or 800. The processes 600, 700, and 800 can also be implemented using hardware in whole or in part. As explained above, some computing devices may have multiple memories and multiple processors, and the steps or operations of each of the processes 600, 700, and 800 may in such cases be distributed using different processors and memories. Use of the terms “processor” and “memory” in the singular herein encompasses computing devices that have only one processor or one memory as well as devices having multiple processors or memories that may each be used in the performance of some but not necessarily all recited steps.

For simplicity of explanation, each process 600, 700, and 800 is depicted and described as a series of steps or operations. However, steps and operations in accordance with this disclosure can occur in various orders and/or concurrently. Additionally, steps or operations in accordance with this disclosure may occur with other steps or operations not presented and described herein. Furthermore, not all illustrated steps or operations may be required to implement a method in accordance with the disclosed subject matter. One or more of the processes 600, 700, or 800 may be repeated for each frame of the input signal.

FIG. 6 is a flowchart diagram of an example of a process 600 for using adaptive directional loop filtering to reduce the number of blocking artifacts in a video stream. At operation 602, a non-perpendicular picture edge can be identified within a block of a current frame of the video stream. In an implementation, the non-perpendicular picture edge can be representative of a texture, for example, depicted by the pixels of the block, which is not perpendicular with respect to a corresponding block boundary. In an implementation, the non-perpendicular picture edge can be defined by a group of pixels, which, for example, can be located in whole or in part within the block and an adjacent block sharing the corresponding block boundary. In an implementation, the group of pixels can be a line of pixels intersecting a block boundary. The non-perpendicular picture edge can have an orientation indicative of an angle at which the non-perpendicular picture edge intersects the corresponding block boundary.

In an implementation, the non-perpendicular picture edge can be identified from data included as part of a video sequence, for example, communicated from a computing device such as the transmitting station 102. In an implementation, the non-perpendicular picture edge can be identified from data stored in memory, such as the memory 204. In an implementation, the non-perpendicular picture edge can be identified by the performance or execution of edge orientation detection software. In an implementation, the non-perpendicular picture edge can be identified by selecting, for example, by a computing device such as the transmitting station 102 or the receiving station 106, data indicative or representative of the non-perpendicular picture edge from a set of data indicative or representative of pictures of a video sequence. In an implementation, the non-perpendicular picture edge can be identified by a computing device, for example, the transmitting station 102 or the receiving station 106, generating data indicative or representative of the non-perpendicular picture edge. Implementations for identifying the non-perpendicular picture edge can include combinations of the foregoing or other manners for identifying the non-perpendicular picture edge.

At operation 604, a directional filter can be selected for adaptive directional loop filtering. In an implementation, the directional filter is selected from a set of directional filters based on a filter angle of the directional filter. The set of directional filters can include any number of directional filters. The filter angle associated with a given directional filter can be an angle between 0 and 180 degrees, exclusive. Thus, in an implementation, the set of directional filters can comprise 178 directional filters, wherein each directional filter has an associated filter angle of one of 1 degree through 179 degrees. In an implementation, the set of directional filters can comprise a set of directional filters most commonly used for directional filtering. For example, the set of directional filters can comprise two directional filters, each having a filter angle of one of 45 degrees and 135 degrees. As another example, the set of directional filters can comprise three directional filters, each having a filter angle of one of 45 degrees, 22.5 degrees, and 67.5 degrees. The complexity of an encoder or decoder can become increased based on the number of directional filters within the set. That is, a set having a large number of directional filters will typically add more complexity to an encoder or decoder than a set having a small number of directional filters.

In an implementation, the directional filter can be selected from the set of directional filters based on filter signaling data included as part of the compressed data of an encoded video sequence. For example, filter signaling data can be coded as part of the video sequence to indicate the angle or orientation of the non-perpendicular picture edge identified at operation 602, above. In an implementation, the filter signaling data can be coded as part of a video sequence in association with a frame including the block to which the non-perpendicular picture edge corresponds. For example, the filter signaling data can be included as part of a header of the corresponding block, a slice (e.g., including the block) of the frame, or the frame itself. In an implementation, the directional filter can be selected from the set of directional filters based on an orientation of the non-perpendicular picture edge, for example, without explicit signaling of the orientation as part of a coded video sequence. For example, the directional filter can be selected based on a similarity to or match between a filter angle of a directional filter and the orientation of the non-perpendicular picture edge.

In an implementation, the directional filter can be selected based on a threshold value for a number of blocking artifacts. For example, the threshold value can be indicative of a maximum number of blocking artifacts to remain in the block after the application of a directional filter. As another example, the threshold value can be indicative of a minimum number of blocking artifacts that will be reduced within the block in response to the application of a directional filter. In an implementation, the directional filter can be selected by applying various directional filters to the block to generate filtered blocks, wherein, if any of the filtered blocks meets the indicated threshold value, the corresponding directional filter can be selected as the directional filter. For example, first, second, and third directional filters having different filter angles (e.g., 45 degrees, 22.5 degrees, and 67.5 degrees, although any other angle between 0 and 180 degrees, exclusive, can be selected as the filter angle for any of the directional filters) can be applied to a block to generate first, second, and third filtered blocks. Where one of the first, second, and third filtered blocks meets the threshold value (e.g., because it contains a total number of blocking artifacts less than the threshold value or because the corresponding directional filter reduced a number of blocking artifacts from the unfiltered version of the block by a certain amount above the threshold value), the corresponding directional filter can be selected as the directional filter to be applied for adaptive directional loop filtering. In an implementation wherein more than one of the first, second, and third filtered blocks meets the threshold value, the directional filter corresponding to the one of the first, second, or third filtered blocks that most exceeds the threshold value can be selected as the directional filter. In an implementation wherein none of the first, second, and third filtered blocks meets the threshold value, the directional filter corresponding to the one of the first, second, or third filtered blocks that most reduced the number of blocking artifacts from the unfiltered version of the block can be selected as the directional filter. In an implementation wherein none of the first, second, and third filtered blocks meets the threshold value, additional directional filters can be considered based on the threshold value.

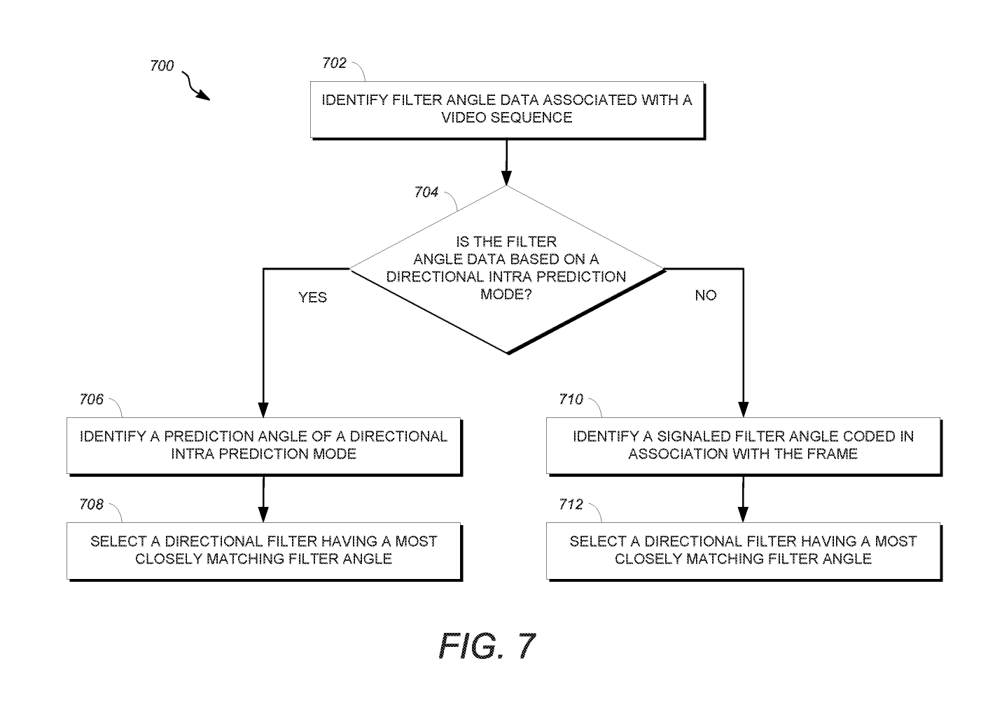

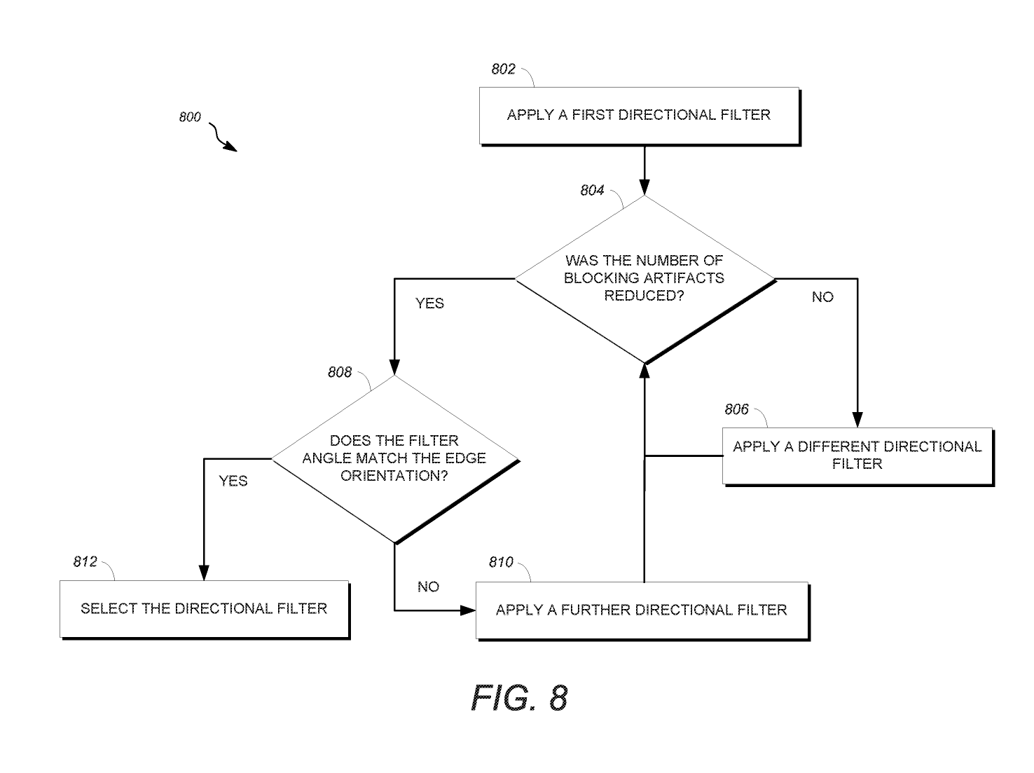

In an implementation, the directional filter can be selected based on a frequency of use. For example, the directional filter most frequently used from the set of directional filters can be selected as the directional filter. In an implementation, the selected directional filter can be directional filter having a filter angle that is a combination of multiple filter angles from the set of directional filters. For example, the selected directional filter can have a filter angle that is the average or summation of multiple filter angles from the set of directional filters. Additional implementations for selecting the directional filter for use in adaptive directional loop filtering from the set of directional filters are discussed below with respect to the processes 700 and 800 of FIGS. 7 and 8, respectively.

In an implementation, the directional filter can be selected from the set of directional filters by selecting, choosing, or otherwise identifying the directional filter, for example, via one or more of the foregoing implementations. In an implementation, the directional filter can be selected from the set of directional filters by reading data stored in memory, such as the memory 204. In an implementation, the directional filter can be selected from the set of directional filters by receiving data indicative or representative of the directional filter, for example, from the transmitting station 102. In an implementation, the directional filter can be selected from the set of directional filters by generating data, for example, by the transmitting station 102 or the receiving station 106, indicative or representative of the directional filter to be used. Implementations for selecting the directional filter can include combinations of the foregoing or other manners for selecting the directional filter.

At operation 606, the directional filter selected at operation 604 above is applied to perform adaptive directional loop filtering. In an implementation, the selected directional filter can be used during an encoding or decoding of a frame of a video sequence by reducing a number of blocking artifacts within a block of the frame, or about a boundary of a block, to which the directional filter applies. For example, the selected directional filter can be used to perform adaptive filtering on the non-perpendicular picture edge identified at operation 602, above. In an implementation, the selected directional filter can be applied by instructions executed by a processor, for example, the CPU 202, and/or stored in memory, such as the memory 204.

FIG. 7 is a flowchart diagram of an example of a process 700 for explicit signaling of a filter angle for adaptive directional loop filtering. That is, a filter angle can be explicitly signaled as part of the video sequence in association with a subject frame, so the directional filter corresponding to the filter angle can be selected for adaptive directional loop filtering. In an implementation, the filter angle can be explicitly signaled as filter signaling data within a header of a block, slice, or frame associated with the block, slice, or frame on which the corresponding directional filter is to be applied. For example, where a frame including a block has already been encoded as part of a video sequence to be decoded, a coded header for the block, the slice including the block, or the frame including the slice and/or block can include filter signaling data indicative of a filter angle to be used for decoding the frame. In an implementation, the filter signaling data can be associated with a directional intra prediction mode used for predicting the block. For example, the prediction angle of a directional intra prediction mode used for encoding the block can be used as the filter angle for selecting the directional filter as part of a decoding operation. In this way, data representative of the intra prediction mode can be explicitly signaled as the filter signaling data.

At operation 702, filter signaling data associated with a video sequence can be identified. In an implementation, the video sequence can be compressed data comprising an encoded video sequence communicated to a decoder by an encoder. The filter signaling data can be associated with a frame of the video sequence, a slice of a frame, a block of a slice, etc. The filter signaling data can be implemented as various data, for example, as data indicative of a directional intra prediction mode used for predicting the block, slice, or frame with which it is associated, or data coded as part of a video sequence in association with the frame, for example, included in a header or other set of data associated with the block, slice, or frame. The filter signaling data can be processed based on its implementation.

At operation 704, the process 700 determines whether the filter signaling data is based on a directional intra prediction mode. In an implementation, this can be done by determining whether a directional intra prediction mode was used for coding the frame or block, and, if so, determining whether data indicative of the prediction angle used by the directional intra prediction mode was coded as part of the video sequence. In response to determining at operation 704 that the filter signaling data is based on a directional intra prediction mode, process 700 continues to operation 706, where a prediction angle of the directional intra prediction mode used to predict the frame or block can be identified. In an implementation, the prediction angle can be identified from the coded frame or a header including data indicative of the prediction angle. Depending on the codec used for coding the frame, the prediction angle can be restricted to one of a set number of possible prediction angles or it can be any angle usable by the codec. In response to identifying the prediction angle, operation 708 completes the process 700 by selecting a directional filter having a filter angle most closely matching the prediction angle from a set of directional filters. In an implementation, operation 708 includes searching the filter angles associated with directional filters of the set to find a filter angle most closely matching the prediction angle identified at operation 706. In an implementation, operation 708 includes determining whether any filter angles associated with directional filters of the set match the prediction angle, and, if so, selecting a such matching directional filter. In an implementation, if no filter angles associated with directional filters of the set match the prediction angle, operation 708 can include determining whether any filter angles associated with the directional filters are within a defined range of the prediction angle (e.g., with 5 degrees of the prediction angle).

In response to determining at operation 704 that the filter signaling data is not based on a directional intra prediction mode, the process 700 continues to operation 710, where a signaled filter angle coded in association with the frame can be identified. In an implementation, the signaled filter angle can be identified from the coded frame or a header including data indicative of the signaled filter angle. In response to identifying the prediction angle, operation 712 completes the process 700 by selecting a directional filter having a filter angle most closely matching the signaled filter angle from a set of directional filters. In an implementation, operation 712 includes searching the filter angles associated with directional filters of the set to find a filter angle most closely matching the signaled filter angle identified at operation 710. In an implementation, operation 712 includes determining whether any filter angles associated with directional filters of the set match the signaled filter angle, and, if so, selecting a such matching directional filter. In an implementation, if no filter angles associated with directional filters of the set match the signaled filter angle, operation 712 can include determining whether any filter angles associated with the directional filters are within a defined range of the signaled filter angle (e.g., within 5 degrees of the signaled filter angle).

FIG. 8 is a flowchart diagram of an example of a process 800 for using one or more filter angles for adaptive directional loop filtering. Implementations of the present disclosure can select the directional filter based on an orientation or angle of the non-perpendicular picture edge to be filtered. For example, a directional filter can be selected based on how an associated filter angle compares to the non-perpendicular picture edge orientation, or multiple directional filters can be selected based on a combination of their associated filter angles. In an implementation, one or more directional filters can be selected for adaptive directional loop filtering where the filter angle thereof matches the non-perpendicular picture edge orientation (e.g., where the angle of the directional filter matches the angle of the picture edge). In an implementation, the one or more directional filters to select can be determined by applying one directional filter at a time and incrementally assessing how many blocking artifacts were reduced from the block as a result. If necessary, for example, where an applied directional filter has not sufficiently reduced the number of blocking artifacts or the filter angle of the applied directional filter does not match or is not similar enough to the non-perpendicular picture edge orientation, further directional filters can be applied.

At operation 802, a first directional filter can be applied to a block having at least a portion of the non-perpendicular picture edge located in it. In an implementation, the first directional filter used can be the directional filter of the set of directional filters that is most frequently used. For example, the most frequently used filter angle may be one of 45 or 135 degrees (e.g., the angles centered between angles perpendicular to the block boundary). However, any filter angle or angles can be the most frequently used filter angle, for example, based on the picture edges filtered by the directional filters of the set of directional filters or other qualities with respect to the video sequence. In an implementation, the first directional filter applied at operation 802 can be randomly selected from the set of directional filters. In an implementation, the first directional filter can be selected based on an index of the set of directional filters. Accordingly, the selection of the first directional filter can be deliberate or arbitrary.

Upon selection, the first directional filter can be applied to the block, for example, to generate a filtered block that can be used as a temporary reference for performing subsequent operations of the process 800. At operation 804, the process 800 determines whether the number of blocking artifacts has been reduced by the application of the first directional filter. For example, the filtered block can have a number of blocking artifacts representative of the number of blocking artifacts that would remain in the actual block after the application of the first directional filter. Thus, in an implementation, operation 804 can include comparing a number of blocking artifacts in the actual block to that of the filtered block. Upon determining that the filtered block has fewer blocking artifacts than the actual block, it can be determined that the number of blocking artifacts would be reduced by the application of the first directional filter.

In response to determining that the application of the first directional filter would not reduce a number of blocking artifacts in the actual block, the process 800 can continue to operation 806 where a different directional filter can be selected for application. In an implementation, operation 806 can include replacing the filtered block generated at operation 802 (or a previous iteration of operation 806, as applicable) with a new filtered block generated based on the application of a directional filter other than the directional filter selected at operation 802 (or any directional filters selected at previous iterations of operation 806, as applicable). The selection of the different directional filter for application at operation 806 can be determined, for example, by implementations usable for selecting the first directional filter at operation 802. In response to selecting a different directional filter at operation 806, process 800 returns to operation 804 to determine whether the application of that different directional filter would reduce the number of blocking artifacts in the block. Implementations for determining this are discussed above.

In response to determining that the application of the first (or different, as applicable) directional filter would reduce the number of blocking artifacts in the actual block, the process 800 can continue to operation 808 to determine whether any additional filtering is necessary or desirable. In an implementation, operation 808 includes comparing the filter angle of the selected directional filter to the orientation of the non-perpendicular picture edge. For example, where the filter angle matches the picture edge orientation, the selected directional filter can be determined to be the optimal directional filter to use for adaptive directional loop filtering. As another example, where the filter angle of the selected directional filter is within a defined range of the picture edge orientation (e.g., within 5 degrees of the picture edge orientation), the selected directional filter can be determined to be sufficient for adaptive directional loop filtering. In an implementation, operation 808 includes comparing the number of blocking artifacts that would be reduced to a threshold value to determine whether the selected directional filter would meet the threshold. For example, the threshold value can be indicative of an acceptable number of blocking artifacts to remain in or a total number of blocking artifacts to be reduced from the actual block by the application of the selected directional filter.

In response to determining that additional filtering is necessary or desirable at operation 808, the process 800 can continue to operation 810 where a further directional filter can be applied in addition to the previously selected directional filter. In an implementation, applying the further directional filter can include replacing the filtered block generated at operation 802 (or operation 806, as applicable) with a new filtered block generated based on the application of the first directional filter selected at operation 802 (or the different directional filter selected at operation 806, as applicable) and the further directional filter selected at operation 810. The selection of the different directional filter for application at operation 806 can be determined, for example, by implementations usable for selecting the first directional filter at operation 802 (or different directional filter at operation 806, as applicable). After the further directional filter is applied at operation 810, the process 800 can return to operation 804 to determine whether the application of the further directional filter would further reduce the number of blocking artifacts in the actual block (e.g., beyond the number remaining in a first iteration of operation 804). In response to determining that the application of the further directional filter would further reduce the number of blocking artifacts, the process 800 can return to operation 808 to determine whether any additional filtering is again necessary or desirable. In response to determining that the application of the further directional filter would not further reduce the number of blocking artifacts, the process 800 can return to operation 806 where a different directional filter can be selected to replace the further directional filter selected at operation 810.

In an implementation, for example, where operation 808 is performed for a second or further iteration, the filter angles of the selected directional filters can be combined for determining whether further additional filtering is necessary or desirable. For example, the filter angles of the directional filters applied at operations 802, 806, and/or 810 can be averaged, summed, or otherwise combined for performing the implementations of operation 808. In response to determining that no additional filtering is necessary or desirable at operation 808, the process 800 can continue to operation 812, where the one or more directional filters selected and applied during the performance of the process 800 can be selected as the directional filter for use in the adaptive directional loop filtering (e.g., as the output of operation 606 of FIG. 6).

Using implementations of the present disclosure, a number of blocking artifacts within a block can be reduced by selecting an adaptive directional filter corresponding to a non-perpendicular picture edge within the block. Whereas filters operative with respect only to the vertical and horizontal block boundaries may fail to accurately reduce the blocking artifacts about the picture edge, the adaptive directional loop filtering of the present disclosure focuses deblocking filter operations on the picture edge based on a non-perpendicular angle at which it intersects applicable block boundaries. Thus, the implementations herein disclosed can be used to preserve the picture content of a frame better than typical horizontal, vertical, or otherwise non-adaptive angled filter operations. A frame processed using the implementations herein disclosed can be used as a reference frame for decoding later frames of a video sequence, for example, because its inclusion of a reduced number of blocking artifacts can be leveraged to reduce blocking artifacts present in such later frames.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general purpose computer or general purpose processor with a computer program that, when executed, carries out any of the respective methods, algorithms and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server and the receiving station 106 can be implemented on a device separate from the server, such as a hand-held communications device. In this instance, the transmitting station 102 can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device and/or a device including an encoder 400 may also include a decoder 500.

Further, all or a portion of implementations of the present invention can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

1. An apparatus, comprising:
at least one processor configured to execute instructions stored in a non-transitory storage medium to:
identify, in a frame of an encoded video sequence, a picture edge that is non-perpendicular with respect to a boundary of a current block of the frame;
select a directional filter from a set of directional filters based on filter signaling data included as part of the encoded video sequence in association with the frame, each directional filter having a respective filter angle; and
apply the selected directional filter to the picture edge.

2. The apparatus of claim 1, wherein selecting the directional filter from the set of directional filters comprises executing instructions to:
identify, as the filter signaling data, a prediction angle associated with a directional intra prediction mode used for encoding the current block; and
select the directional filter from the set of directional filters having a filter angle most closely matching the prediction angle.

3. The apparatus of claim 1, wherein selecting the directional filter from the set of directional filters comprises executing instructions to:
identify, as the filter signaling data, a signaled filter angle coded in association with the frame; and
select the directional filter from the set of directional filters having a filter angle most closely matching the signaled filter angle.

4. The apparatus of claim 1, wherein selecting the directional filter from the set of directional filters comprises executing instructions to:
select a most frequently used directional filter of the set of directional filters as the directional filter.

5. The apparatus of claim 1, wherein applying the selected directional filter to the picture edge comprises executing instructions to:
apply adaptive filtering to a group of pixels intersecting the boundary of the current block using the selected directional filter, the group of pixels defined by the picture edge.

6. The apparatus of claim 1, wherein a portion of the picture edge is located within a second block of the frame, wherein the boundary separates the current block and the second block.

7. The apparatus of claim 1, wherein the respective filter angle of each directional filter of the set of directional filters is an angle between 0 and 180 degrees, exclusive.

8. An apparatus, comprising:
at least one processor configured to execute instructions stored in a non-transitory storage medium to:
identify, in a current block of a frame, a group of pixels defining a picture edge that is non-perpendicular with respect to a boundary of the current block;
select a directional filter from a set of directional filters based on an orientation of the picture edge, each directional filter having a respective filter angle; and
apply the selected directional filter to the picture edge during an encoding or decoding of the frame.

9. The apparatus of claim 8, wherein selecting the directional filter from the set of directional filters comprises executing instructions to:
apply a first directional filter of the set of directional filters, the first directional filter having a first filter angle, to the current block to generate a first filtered block;
in response to determining that a number of blocking artifacts of the initial first filtered block is less than a number of blocking artifacts of the current block, applying a second directional filter of the set of directional filters, the second directional filter having a second filter angle, to the first filtered block to generate a second filtered block; and
in response to determining that a number of blocking artifacts of the second filtered block is less than the number of blocking artifacts of the first filtered block, selecting the first directional filter and the second directional filter as the directional filter,
wherein the filter angle of the selected directional filter is a combination of the first filter angle and the second filter angle.

10. The apparatus of claim 8, wherein selecting the directional filter from the set of directional filters comprises executing instructions to:
apply first, second, and third directional filters of the set of directional filters to the current block to generate first, second, and third filtered blocks, respectively, the first, second, and third directional filters having different filter angles; and
in response to determining that one of the first, second, or third filtered blocks has a number of blocking artifacts below a threshold value, selecting a corresponding one of the first, second, or third directional filters as the directional filter; and
in response to determining that more than one of the first, second, or third filtered blocks has a number of blocking artifacts below the threshold value, selecting directional filter corresponding to whichever of the first, second, and third filtered blocks has a least number of blocking artifacts as the directional filter.

11. The apparatus of claim 8, wherein selecting the directional filter from the set of directional filters comprises executing instructions to:
select a most frequently used directional filter of the set of directional filters as the directional filter.

12. The apparatus of claim 8, wherein applying the selected directional filter to the picture edge comprises executing instructions to:
apply adaptive filtering to the identified group of pixels using the selected directional filter, the group of pixels intersecting the boundary of the current block.

13. The apparatus of claim 8, wherein the identified group of pixels includes pixels located within a second block of the frame, wherein the boundary separates the current block and the second block.

14. The apparatus of claim 8, wherein the respective filter angle of each directional filter of the set of directional filters is an angle between 0 and 180 degrees, exclusive.

15. A method for encoding or decoding a video signal using a computing device, the video signal including frames defining a video sequence, the frames having blocks, and the blocks having pixels, the method comprising:
identifying, in a current block of a current frame of the video sequence, a group of pixels defining a picture edge that is non-perpendicular with respect to a boundary of the current block;
selecting a directional filter from a set of directional filters based on one of an orientation of the picture edge or filter signaling data included as part of an encoded video sequence in association with the current frame, each directional filter having a filter angle; and
applying the selected directional filter to the picture edge during an encoding or decoding of the frame.

16. The method of claim 15, wherein selecting the directional filter from the set of directional filters comprises:
identifying, as the filter signaling data, a prediction angle associated with a directional intra prediction mode used for encoding the current block; and
selecting the directional filter from the set of directional filters having a filter angle most closely matching the prediction angle.

17. The method of claim 15, wherein selecting the directional filter from the set of directional filters comprises:
identifying, as the filter signaling data, a signaled filter angle coded in association with the current frame; and
selecting the directional filter from the set of directional filters having a filter angle most closely matching the signaled filter angle.

18. The method of claim 15, wherein selecting the directional filter from the set of directional filters comprises:
applying a first directional filter of the set of directional filters, the first directional filter having a first filter angle, to the current block to generate a first filtered block;
in response to determining that a number of blocking artifacts of the first filtered block is less than a number of blocking artifacts of the current block, applying a second directional filter of the set of directional filters, the second directional filter having a second filter angle, to the first filtered block to generate a second filtered block; and
in response to determining that a number of blocking artifacts of the second filtered block is less than the number of blocking artifacts of the first filtered block, selecting the first directional filter and the second directional filter as the directional filter,
wherein the filter angle of the selected directional filter is a combination of the first filter angle and the second filter angle.

19. The method of claim 15, wherein selecting the directional filter from the set of directional filters comprises:
applying first, second, and third directional filters of the set of directional filters to the current block to generate first, second, and third filtered blocks, respectively, the first, second, and third directional filters having different filter angles; and
in response to determining that one of the first, second, or third filtered blocks has a number of blocking artifacts below a threshold value, selecting a corresponding one of the first, second, or third directional filters as the directional filter; and
in response to determining that more than one of the first, second, or third filtered blocks has a number of blocking artifacts below the threshold value, selecting a directional filter corresponding to whichever of the first, second, and third filtered blocks has a least number of blocking artifacts as the directional filter.

20. The method of claim 15, wherein selecting the directional filter from the set of directional filters comprises:
selecting a most frequently used directional filter of the set of directional filters as the directional filter.
